(19) United States
(12) Patent Application Publication
(10) Pub. No.: US 2025/0021980 A1
(43) Pub. Date: Jan. 16, 2025

(54) METHOD AND SYSTEM FOR GENERATING ORDERED RULE SETS FOR FRAUD DETECTION IN ELECTRONIC TRANSACTIONS

(71) Applicant: Mastercard International Incorporated, Purchase, NY (US)

(72) Inventors: Diksha SHRIVASTAVA, Indore (IN); Yatin KATYAL, Rohtak (IN); Suhas POWAR, Kolhapur (IN); Harsh BANSAL, Gwalior (IN); Sourojit BHADURI, Jamshedpur (IN); Dhruv KANWAL, New York, NY (US)

(21) Appl. No.: 18/221,019

(22) Filed: Jul. 12, 2023

(51) Int. Cl. G06Q 20/40; G06Q 20/02

(52) U.S. Cl. CPC G06Q 20/4016; G06Q 20/02

(57) ABSTRACT

A method for generating fraud and approval rules for a decision engine for detecting fraud in electronic transactions includes: receiving transaction data for a plurality of electronic transactions, the transaction data including a fraud determination and data values for the respective electronic transaction; applying a first rule of a plurality of rules to the electronic transactions to identify a first subset of transactions that satisfy the first rule and include a fraud determination indicative of fraud; filtering the first subset of transactions out of the plurality of electronic transactions; repeating the application step and filtering step using additional rules of the plurality of rules until a threshold criteria is met; and generating a rule order for the first rule and the additional rules based on at least a size of the subset of transactions identified using the respective rule.

### FIELD

The present disclosure relates to the generation of ordered rule sets for use in determining fraud in electronic transactions, specifically the generation of fraud and approval rules for a decision engine for detecting fraud in electronic transactions.

### BACKGROUND

Fraud in electronic transactions costs consumers, merchants, payment processors, and other involved entities millions and millions of dollars per year all over the world. When fraud occurs, it can have a devastating effect on those involved that can go well beyond a negative financial cost; it can adversely affect the trust each entity in a system has with the other entities in that system, which can result in significantly less participation and, in turn, lead to even more negative results. As such, entities involved in transaction systems utilize significant resources to detect and prevent fraud from occurring.

One such method often used by payment processors and financial institutions is fraud scoring. Various algorithms are applied to data for a new transaction to generate a fraud score for the transaction, where the score can indicate the likelihood that fraud is occurring for the transaction. Such methods typically use historical transaction data to identify trends and patterns, where the fraud score is a representation of how similar the new transaction is to past transactions where fraud occurred. Typical factors that illustrate a likelihood of fraud can include a merchant regularly found to be conducting fraud, a transaction for a significantly higher amount than standard for a party involved in the transaction, or a transaction that takes place at a geographic location significantly different from typical locations for an involved party, etc.

While such factors can be useful in determining a fraud score for a transaction, these factors are traditionally identified by analyzing trends of past transactions and each factor is applied to a new transaction concurrently, which can be inefficient and ineffective. Additionally, such factors are often only useful for traditional electronic payment transactions funded via credit cards or other payment cards that are processed via existing payment networks. Blockchain transactions utilize cryptographic currency and often lack the level of detail used in many traditional fraud factors, which makes them significantly more difficult for accurate fraud scoring. Furthermore, there is a significant lack of tools for identifying fraud rules for blockchain transactions that have a high enough success rate and low enough false positive rate to justify their use.

Thus, there is a need for a technological improvement to existing fraud detection systems for generating fraud rules for use in all types of electronic transactions that are more effective and efficient than traditional systems.

### SUMMARY

The present disclosure provides a description of systems and methods for generating fraud and approval rules for a decision engine for detecting fraud in electronic transactions. A processing system receives transaction data for a group of transactions whose fraud disposition (e.g., positive for fraud or approved and processed) is known, where the transactions can be traditional electronic payment transactions funded via fiat currency, blockchain transactions funded via cryptographic currency, or a combination thereof. The processing system can apply one of a plurality of rules to the transactions to identify a subset of the transactions associated with the rule. The subset of transactions can then be filtered out from the set of transactions. The processing system can then repeat with the application of a new rule and subsequent filtering out of identified transactions and continue to repeat with additional rules until the remaining set of transactions is below a threshold, the fraud rate of transactions meets a threshold, or other criteria is met. The processing system can then order the rules based on their effectiveness (e.g., a rule that identified more fraudulent transactions can be considered more effective than a rule that identified less fraudulent transactions). The generated ordered list of rules can then be used for future fraud determinations, where the decision tree method for identifying and ordering the rules can have significantly greater effectiveness and is applicable to all types of payment transactions.

A method for generating fraud and approval rules for a decision engine for detecting fraud in electronic transactions includes: receiving, by a receiver of a processing server, transaction data for a plurality of electronic transactions, where the transaction data includes at least a fraud determination and one or more data values for the respective electronic transaction; applying, by a processor of the processing server, a first rule of a plurality of rules to the plurality of electronic transactions to identify a first subset of the plurality of electronic transactions that satisfy the first rule and include a fraud determination indicative of fraud; filtering, by the processor of the processing server, the first subset of the plurality of electronic transactions out of the plurality of electronic transactions; repeating, by processor of the processing server, the application step and filtering step using additional rules of the plurality of rules until a threshold criteria is met; and generating, by the processor of the processing server, a rule order for the first rule and the additional rules of the plurality of rules based on at least a size of the subset of the plurality of electronic transactions identified using the respective rule of the plurality of rules.

A system for generating fraud and approval rules for a decision engine for detecting fraud in electronic transactions includes a processing server that includes: a receiver receiving transaction data for a plurality of electronic transactions, where the transaction data includes at least a fraud determination and one or more data values for the respective electronic transaction; and a processor applying a first rule of a plurality of rules to the plurality of electronic transactions to identify a first subset of the plurality of electronic transactions that satisfy the first rule and include a fraud determination indicative of fraud, filtering the first subset of the plurality of electronic transactions out of the plurality of electronic transactions, repeating the application step and filtering step using additional rules of the plurality of rules until a threshold criteria is met, and generating a rule order for the first rule and the additional rules of the plurality of rules based on at least a size of the subset of the plurality of electronic transactions identified using the respective rule of the plurality of rules.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for generating fraud and approval rules for a decision engine in accordance with exemplary embodiments;

FIG. 2 is a block diagram illustrating the processing server in the system of FIG. 1 for generating fraud and approval rules for a decision engine in accordance with exemplary embodiments;

FIG. 3 is a flow diagram illustrating a process for generating fraud and approval rules for a decision engine by the processing server in the system of FIG. 1 in accordance with exemplary embodiments;

FIG. 4 is a flow chart illustrating an exemplary method for generating fraud and approval rules for a decision engine in accordance with exemplary embodiments; and

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Generating Fraud and Approval Rules

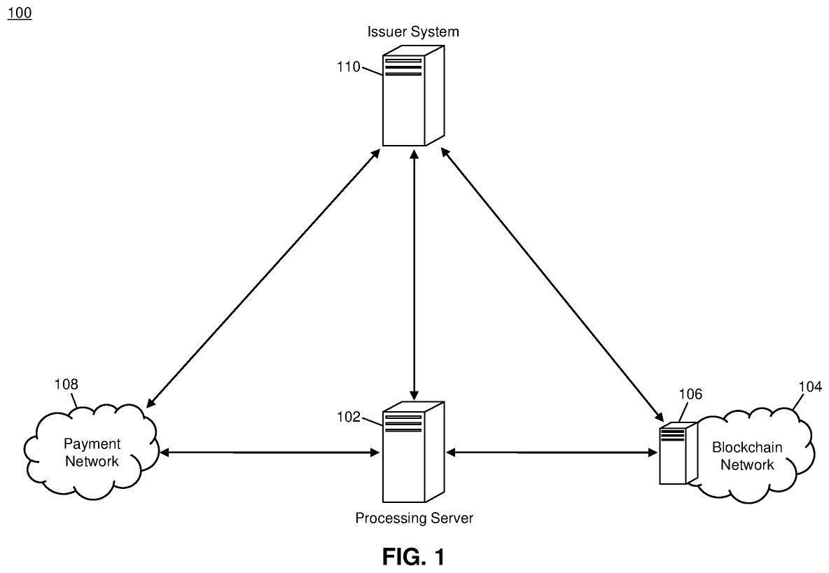

FIG. 1 illustrates a system 100 for the generation of fraud and approval rules for use by a decision engine for fraud determinations in electronic transactions. The system 100 can include a processing server 102. The processing server 102, discussed in more detail below, can be configured to use existing transaction data and fraud determinations to generate fraud and approval rules through use of a decision tree process and rule ordering that can provide greater effectiveness in fraud prevention for all types of electronic transactions. The processing server 102 can be configured to generate rules for detecting likelihood of fraud for all types of electronic transactions, which includes blockchain transactions conducted via a blockchain network 104 for the transfer of cryptographic currency as well as traditional payment transactions processed via a payment network 108 for the transfer of fiat currency. As discussed herein, “transaction” can refer to any suitable type of transaction regardless of the type of currency used, processing network utilized, etc.

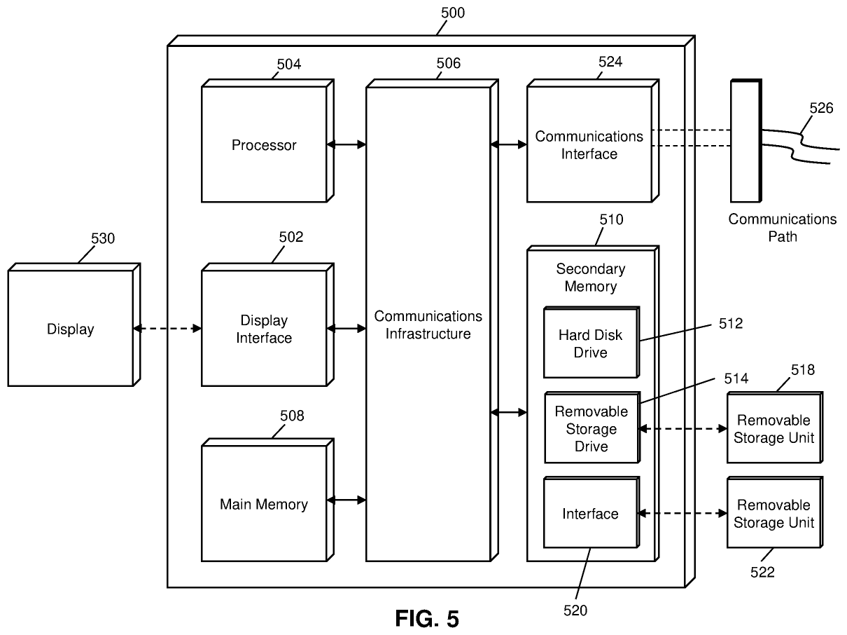

The blockchain network 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in the blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” can refer specifically to the private key. In other cases, the term “blockchain wallet” can refer to a computing device that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency that is generated using the sender's private key, a blockchain address of the recipient of currency generated using the recipient's public key, and a blockchain currency amount that is transferred, or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in the blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

The system 100 can also include the payment network 108. The payment network 108 can be a system or network used for the transfer of money via the use of cash-substitutes for thousands, millions, and even billions of transactions during a given period. Payment networks can use a variety of different protocols and procedures in order to process the transfer of money for various types of transactions. Transactions that can be performed via a payment network can include product or service purchases, credit purchases, debit transactions, fund transfers, account withdrawals, etc. Payment networks can be configured to perform transactions via cash-substitutes, which can include payment cards, letters of credit, checks, transaction accounts, etc. Examples of networks or systems configured to perform as payment networks include those operated by Mastercard®, and other payment network operators, etc. Use of the term “payment network” herein can refer to both the payment network as an entity, and the physical payment network, such as the equipment, hardware, and software comprising the payment network, which are also known as “payment rails.”

As used herein, “payment card” can refer to a card, which can be a physical card or a virtual card, which can be presented to a merchant for use of the associated account in funding a payment transaction. In some cases, the term payment card can refer to a digital token provisioned to a computing device that is used for payment transactions. Payment cards can, in many cases, be issued to a consumer by an issuer (e.g., issuer system 110), which can be an entity that establishes (e.g., opens) a letter or line of credit in favor of a beneficiary, and honors drafts drawn by the beneficiary against the amount specified in the letter or line of credit. In many instances, the issuer can be a bank or other financial institution authorized to open lines of credit. In some instances, any entity that can extend a line of credit to a beneficiary may be considered an issuer. The line of credit opened by the issuer can be represented in the form of a payment account and may be drawn on by the beneficiary via the use of a payment card.

As used herein, “payment transaction” can refer to a transaction between two entities in which money or other financial benefit is exchanged from one entity to the other. The payment transaction can be a transfer of funds, for the purchase of goods or services, for the repayment of debt, or for any other exchange of financial benefit as will be apparent to persons having skill in the relevant art. In some instances, payment transaction can refer to transactions funded via a payment card and/or payment account, such as credit card transactions. Such payment transactions can be processed via an issuer system 110, payment network 108, and acquirer. The process for processing such a payment transaction can include at least one of authorization, batching, clearing, settlement, and funding. Authorization can include the furnishing of payment details by the consumer to the merchant system, the submitting of transaction details (e.g., including the payment details) from the merchant system to their acquirer, and the verification of payment details with the issuer system 110 of the consumer's payment account used to fund the transaction. Batching can refer to the storing of an authorized transaction in a batch with other authorized transactions for distribution to an acquirer. Clearing can include the sending of batched transactions from the acquirer to a payment network 108 for processing. Settlement can include the debiting of the issuer by the payment network 108 for transactions involving beneficiaries of the issuer. In some instances, the issuer can pay the acquirer via the payment network 108. In other instances, the issuer can pay the acquirer directly. Funding can include payment to the merchant from the acquirer for the payment transactions that have been cleared and settled. It will be apparent to persons having skill in the relevant art that the order and/or categorization of the steps discussed above performed as part of payment transaction processing.

When participating in an electronic transaction, an involved party can be interested in fraud prevention, such as to ensure that they are not being taken advantage of by another party in the transaction. Traditionally, an issuer system 110 will review transaction details for a new payment transaction that is submitted for approval to determine a likelihood of fraud, often comparing the new transaction with past transactions involving the consumer. A transaction that the issuer system 110 determines could be fraudulent can be denied, or the issuer system 110 can request explicit approval by the consumer for the suspect transaction via a computing device. However, existing systems have a substantial false positive rate, which results in the decline of many genuine transactions, or can require regular intervention by consumers. For blockchain transactions, fraud prevention is significantly harder with a significantly higher false positive rate, which has led to a lot of financial institutions being unwilling to participate in blockchain transactions.

To solve these problems, the processing server 102 can be configured to generate fraud and approval rules for use in determining likelihood of fraud for future electronic transactions through a new and improved process. The processing server 102 can collect transaction data for a plurality of electronic transactions. The processing server 102 can receive transaction data for payment transactions from one or more payment networks 108 and transaction data for blockchain transactions from one or more blockchain networks 104. In some cases, the processing server 102 can use transaction data for both types of transactions when determining fraud rules. In other cases, the processing server 102 can determine separate fraud rules for each type of transaction, where the processing server 102 can only use transaction data for that type of transaction when determining the respective fraud rules. In some cases, the processing server 102 can determine separate fraud rules for both types of transactions but can still utilize transaction data for both types of transactions.

Transaction data can include any data related to an electronic transaction that can be useful in the application of rules to transaction data for the determination of a likelihood of fraud. Transaction data can include, for example, amount, time, date, currency type, processor network identity, merchant identifier, merchant category code, bank identification number, product data, loyalty data, reward data, blockchain wallet data, payment account data, geographic location, issuer data, acquirer data, etc. Transaction data received by the processing server 102 can also include a fraud determination for each electronic transaction, which can indicate if the transaction was determined to be fraudulent or have another indication (e.g., non-fraudulent, approved, processed, cleared, etc.). In some cases, the processing server 102 can receive data for individual electronic transactions. In other cases, the processing server 102 can receive aggregated transaction data, such as groups of transactions having the same or similar transaction data that has the same fraud determination.

In addition to transaction data, the processing server 102 can also have a plurality of rules for application to transaction data. The rules can be rules regarding one or more data values in transaction data, which can vary based on the type of transaction to which the rule applies. The rules may be developed based on one or more of transaction features, customer behavior, and merchant behavior. For example, rules may be based on features such as geographic location, transaction amount, merchant identifier, merchant category code, country code, currency, payment method, etc. In a more detailed example, the processing server 102 could have the following set of rules:
1. Transaction amount greater than $1,000.
2. Transaction taking place in United States.
3. Merchant category code of 1234.
4. Merchant identifier other than 98765 or 43210.
5. Transaction conducted using a payment method other than a debit card.
6. Transaction taking place in United States with a merchant category code of 6789.

It will be apparent to persons having skill in the relevant art that the above list of rules is merely an example, where lists could include a wide variety of rules regarding a wide variety of transaction data and could include significantly more rules. In some cases, the plurality of rules can include multiple rules related to the same data value in transaction data. For example, there can be multiple rules each regarding the geographic location of a transaction, multiple rules regarding merchant category codes, etc.

The processing server 102 can start with the full set of received transaction data and full list of rules and begin the rule generation process by selecting a first rule from the plurality of rules. The first rule can be selected using any suitable method, such as based on a prior ordering, random selection, selected by a user, etc. The processing server 102 can then apply the first rule to the full set of electronic transactions for which transaction data is received. In applying the rule, the processing server 102 can identify a subset of the electronic transactions to which the rule applies. For instance, in the above example rule set, the processing server 102 can apply the first rule and identify a subset of the electronic transactions whose transaction amount is greater than $1,000. Once the subset is identified, the processing server 102 can further divide the subset into those transactions with a positive fraud determination (“fraudulent transactions”) and those without a positive fraud determination (“non-fraudulent transactions”). The identified subset of transactions is then filtered out from the full set of electronic transactions by the processing server 102.

The processing server 102 can then repeat the process using different rule in the plurality of rules on the remaining electronic transactions, where a subset of the remaining electronic transactions is identified via application of the different rule. In some cases, the processing server 102 can apply the rules in an order such that the maximum number of remaining transactions are identified via application of the rule. In such cases, the processing server 102 can evaluate the application of each rule for such value before proceeding. In some embodiments, beam search can be used in order to select the most promising rule to apply next in the process, where the beam width can be infinite or any other suitable value. Once the transactions have been identified via the next rule, the processing server 102 can again divide the new subset of electronic transaction into fraudulent transactions and non-fraudulent transactions. The processing server 102 can continue to repeat the process with additional rules until a threshold criteria is met. The threshold criteria can be any criteria that is suitable for the processing server 102 with respect to the goals of fraud detection. The threshold criteria can include a number of transactions remaining after filtering, a percentage of transactions remaining after filtering, a number or percentage of fraudulent transactions filtered, a number or percentage of non-fraudulent transactions filtered, a number or percentage of applied rules, etc.

Once the threshold criteria have been met and process stopped, the processing server 102 can order the rules that were applied. The rules can be ordered in a list of precedence that can be based on the number of transactions identified in the subset via application of the rule. For example, a rule that applies to 60% of remaining transactions can be giving an earlier order (e.g., higher precedence) than a rule that applied to only 10% of transactions remaining. In some cases, the ordering can be based on a number of fraudulent transactions identified in the subset via application of the rule, a percentage of fraudulent transactions identified in the subset compared to number of transactions in the subset, or a percentage of fraudulent transactions identified in the subset compared to the total number of fraudulent transactions in the full set of electronic transactions. The ordered list of rules can then be created from the applied list of rules, which can result in an ordered list of fraud rules. The ordered list of fraud rules can then be used in fraud scoring or fraud determinations for future electronic transactions.

The processing server 102 can provide the ordered list of fraud rules to payment networks 108, blockchain networks 104, blockchain nodes 106, issuer systems 110, acquirers, or other entities for use in fraud scoring and fraud determinations of future electronic transactions. In some cases, the processing server 102 can be configured to provide fraud scoring and/or fraud determinations for transactions on behalf of any entity involved in a transaction. For instance, a consumer can provide information for a potential new transaction directly to the processing server 102 for scoring, such that the consumer can decide whether or not to proceed with the transaction based on the provided score. In another example, an issuer system 110 can provide transaction data or an authorization request for a new payment transaction to the processing server 102 for scoring, where the processing server 102 can apply the ordered list of rules to the new transaction to generate a score and provide the score back to the issuer system 110, which can then use the score in determining whether to approve or decline the new transaction.

In some embodiments, the processing server 102 can be configured to generate two ordered rule sets: a set of fraud rules and a set of approval rules. In such embodiments, the rules can be ordered based on numbers or percentages of fraudulent and non-fraudulent transactions identified via the application of each rule, respectively. For instance, a rule that applies to 10% of all fraudulent transactions but applies to 60% of all non-fraudulent transactions can be ordered higher on the list of approval rules than the list of fraud rules. In such embodiments, both sets of rules can be used in fraud scoring and/or fraud determinations of future transactions. For example, data for a new blockchain transaction can be provided to the processing server 102. The processing server 102 can apply the ordered set of fraud rules to the new blockchain transaction to generate a fraud score of 47 out of 100, indicative of a medium likelihood of fraud, but can also apply the ordered set of approval rules to the new blockchain transaction to generate an approval score of 89 out of 100, indicative of a very high likelihood of approval, as just two examples. Both scores can be provided to the consumer, issuer system 110, or other requesting entity, or can be used together to generate an overall score. In the above example, the transaction can involve an entity that is new to the blockchain network 104 where the blockchain transaction is being processed, which can lead to the medium likelihood of fraud due to the lack of history and potential for fraud with a new entity, but where the rest of the transaction data suggests a genuine transaction, which can result in the high approval score. In traditional systems, such a transaction would likely be prevented due to fraud, but, in the system 100, could still take place and be successfully processed due to the use of ordered rule sets.

As discussed above, the processing server 102 can apply new rules to the full set of electronic transactions and continue to apply rules to the electronic transactions that remain after filtering. In an alternative embodiment, the processing server 102 can apply the first rule to the full set of electronic transactions to identify a subset of electronic transactions to which the rule applies and then apply the next rule to only the electronic transactions in the subset. The processing server 102 can then continue to do so until the threshold criteria, such as when no additional rules apply to transactions in the remaining subset, there is a predetermined number of transactions left in the remaining subset, the percentage of electronic transactions in the remaining subset of the full set of electronic transactions is below a predetermined value, etc.

In some embodiments, the processing server 102 can similarly apply new rules to only electronic transactions divided in the subset of electronic transactions. For instance, the processing server 102 can apply the first rule to identify a subset of electronic transactions that are divided into fraudulent and non-fraudulent transactions and then apply the next rule to only the fraudulent transactions in the subset. The processing server 102 can then identify a new subset of transactions from the fraudulent transactions, divide the new subset into fraudulent and non-fraudulent transactions, and then apply the next rule to the newly divided fraudulent transactions. The processing server 102 can continue to apply rules accordingly until the threshold criteria is met. The processing server 102 can then generate the ordered rule set, which can be considered fraud rules due to the applicability to the fraudulent transactions. The processing server 102 can similarly apply new rules to only the non-fraudulent transactions divided in the subsets until a threshold criteria is met, where those rules can be ordered to generate a set of approval rules.

In some embodiments, the processing server 102 can repeat the process of generating an ordered rule set using different initial ordering of rules. For example, the processing server 102 can have a list of 50 rules to apply to the full set of electronic transactions and can randomly order the list of 50 rules for applying. The processing server 102 can then perform the above process to generate the ordered rule set, and then repeat the process using a different random order. The processing server 102 can continue to do so any number of times until a threshold criteria for the ordered rule set itself is met, such as a minimum number of rules in the ordered rule set, a maximum number of rules in the ordered rule set, a threshold fraud or approval rate is met, etc.

In some embodiments, the processing server 102 can repeat the process of generating an ordered rule set to generate an updated ordered rule set using new transaction data. For example, the processing server 102 may update the ordered rule set by applying the rules only to the new transaction data, e.g., transaction data that has been received since a last time the ordered rule set was generated by the processing server, and/or the processing server 102 may update the ordered rule set by applying the rules the a combination of the original transaction data and the new transaction data. The processing server 102 may update the generated ordered rule set periodically such as weekly, monthly, quarterly, etc., or after a defined threshold of new transaction data has been received.

In some embodiments, the processing server 102 may generate an ordered rule set as discussed above based on the geographic location of the electronic transactions such that different ordered rule sets can be generated for different geographic locations. For example, a first ordered rule set can be generated for all electronic transaction having a geographic location in the United States or region thereof, a second ordered rule set can be generated for all electronic transaction having a geographic location in Canada or region thereof, a third ordered rule set can be generated for all electronic transaction having a geographic location in Europe or region thereof, etc.

The methods and systems discussed herein provide for the generation of fraud and approval rules for use in a decision engine for fraud scoring and fraud determinations for electronic transactions. By applying each rule of a plurality of rules in order, filtering the results, and generating an ordered rule set as a result, the methods and systems discussed herein can result in fraud and approval rules that are significantly more effective than traditional systems. In addition, generating separate fraud and approval rule sets can also provide greater protection against false positives to have an even greater impact in fraud reduction with minimal interruption to entities involved in transactions. In addition, the methods and systems discussed herein are applicable to all types of transactions including blockchain transactions, which is a technological improvement over many existing fraud detection systems that are applicable only to fiat-based payment transactions.

### Processing Server

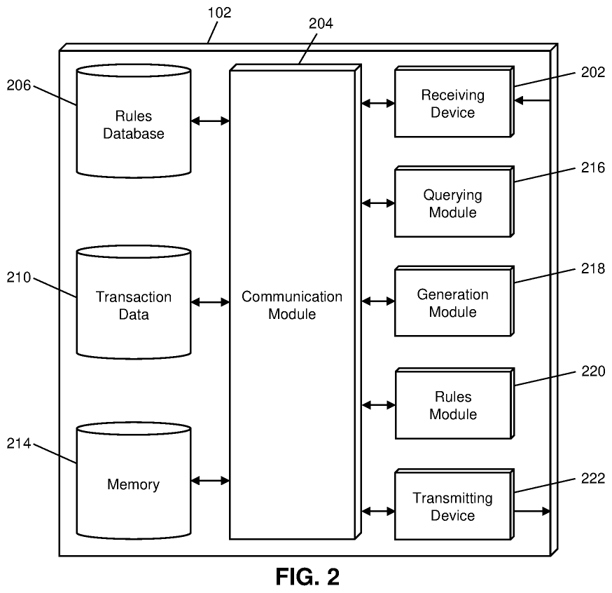

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, components of the system 100, such as blockchain nodes 106 and the issuer system 110 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from blockchain nodes 106, payment networks 108, issuer systems 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that can be superimposed or otherwise encoded with transaction data for blockchain transactions, which can include blockchain data entries, destination addresses, transaction amounts, geographic locations, device identifiers, node identifiers, currency types, times and/or dates, wallet identifiers, public keys, digital signatures, fraud determinations, etc. The receiving device 202 can also be configured to receive data signals electronically transmitted by payment networks 108 and issuer systems 110, which can be superimposed or otherwise encoded with transaction data for electronic transactions, which can include transaction messages, authorization requests, authorization responses, times, dates, transaction amounts, currency identifiers, point of sale identifiers, product data, issuer data, acquirer data, merchant identifiers, merchant category codes, transaction type data, fraud determinations, etc. The receiving device 202 can also be configured to receive data signals electronically transmitted by blockchain nodes 106, payment networks 108, and issuer systems 110 that can be superimposed or otherwise encoded with fraud rule requests, fraud scoring requests, transaction data, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, rules module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include a rules database 206. The account database 206 can be configured to store one or more rules using a suitable data storage format and schema. The rules database 206 can be a relational database that utilizes structured query language for the storage, identification, modifying, updating, accessing, etc. of structured data sets stored therein. Rules stored in the rules database 206 can be rules that are applicable to one or more electronic transactions and can include one or more data elements and one or more values associated therewith. In some cases, rules can be associated with an ordering or precedence, have applicability rules (e.g., to only blockchain transactions, to only electronic transactions, to only fraudulent transactions, etc.), or be dependent on other rules. The rules database 206 can also be used by the processing server 102 to store ordered rule sets, such as determined using the processes discussed herein.

The processing server 102 can also include transaction data 210, which can be stored in a memory 214 of the processing server 102 or stored in a separate area within the processing server 102 or accessible thereby. The transaction data 210 can include data related to one or more electronic transactions, which can include both blockchain transactions and payment transactions. Transaction data 210 can include data for individual transactions and/or aggregated transaction data. In some cases, data stored in the transaction data 210 can be separated into subsets and/or other divisions, as discussed above. In other cases, a transaction stored in the transaction data 210 can have data associated therewith regarding its inclusion in one or more data subsets or divisions.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, blockchain data, transaction messaging data, threshold criteria, threshold values, predetermined values, ordering rules and criteria, etc.

The processing server 102 can include a querying module 216. The querying module 216 can be configured to execute queries on databases to identify information. The querying module 216 can receive one or more data values or query strings and can execute a query string based thereon on an indicated database, such as the memory 214 of the processing server 102 to identify information stored therein. The querying module 216 can then output the identified information to an appropriate engine or module of the processing server 102 as necessary. The querying module 216 can, for example, execute a query on the rules database 206 to identify a plurality of rules to use in generating a new ordered rule set, and/or execute a query on the transaction data 210 to identify transaction data to apply the rules to.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate sets of electronic transactions (e.g., via filtering), ordered rule sets using applicable criteria and rule data, response messages, fraud scores, fraud determinations, new rules, etc.

The processing server 102 can also include a rules module 220. The rules module 220 can be configured to apply rules to electronic transactions for the processing server 102 as part of the functions discussed herein. The rules module 220 can receive instructions as input, which can also include transaction data, existing rules, or sets of electronic transactions to be used in applying one or more rules, can apply one or more rules as requested, and can output a result of the application to another module or engine of the processing server 102. The rules module 220 can, for example, be configured to apply rules to a set of electronic transactions, apply rules in an ordered rule set to a new electronic transaction, etc.

The processing server 102 can also include a transmitting device 222. The transmitting device 222 can be configured to transmit data over one or more networks via one or more network protocols. In some instances, the transmitting device 222 can be configured to transmit data to blockchain nodes 106, payment networks 108, issuer systems 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes 106, payment networks 108, and issuer systems 110 that are superimposed or otherwise encoded with requests for transaction data, ordered rule sets, requests for rules, fraud scores, fraud determinations, response messages, etc.

### Process for Generating Ordered Rule Sets

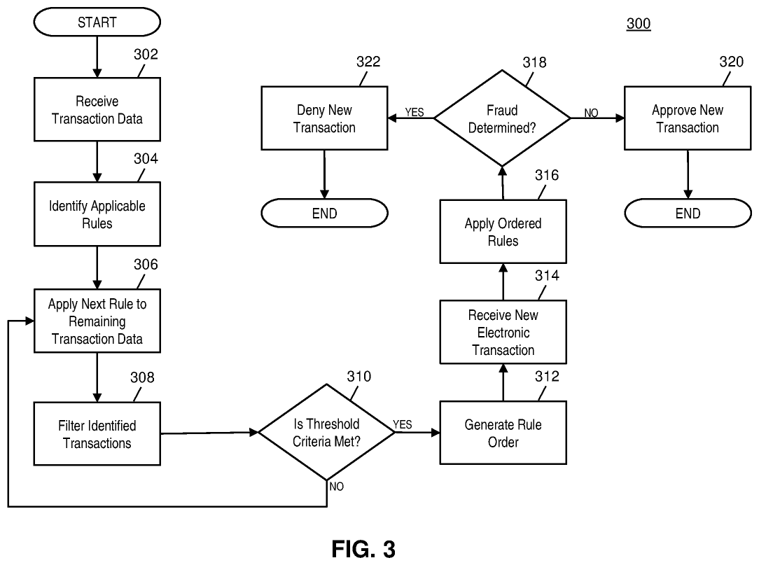

FIG. 3 illustrates a process 300 for the generation of an ordered set of fraud rules and approval rules as performed by the processing server 102 in the system 100 of FIG. 1.

In step 302, the receiving device 202 of the processing server 102 can receive transaction data for a plurality of electronic transactions. The transaction data can be received by any number of sources, such as blockchain nodes 106 for one or more blockchain networks 104, one or more payment networks 108, one or more issuer systems 110, etc. The transaction data can be data for individual transactions and/or aggregated transactions, and where the transactions can be blockchain transactions, payment transactions, or a mix of both blockchain and payment transactions. The transaction data can include one or more data values for the associated transactions as well as a fraud determination for the associated transactions. The received transaction data can be combined together as a set of electronic transactions. In step 304, the querying module 216 of the processing server 102 can execute a query on the rules database 206 of the processing server 102 to identify a plurality of rules that are applicable to the received transaction data. For instance, if the transaction data only includes payment transactions, rules that are applicable only to blockchain transactions will not be identified in step 304. In some cases, identification of the applicable rules can include identification of an order for application of the applicable rules.

In step 306, the rules module 220 of the processing server 102 can apply the next rule in the plurality of rules to the remaining transaction data in the set of electronic transactions. Application of the rules can result in the identification of a subset of electronic transactions to which the next rule is applicable, which can include fraudulent transactions, non-fraudulent transactions, or a combination thereof. In step 308, the generation module 218 of the processing server 102 can filter out the identified subset of electronic transactions from the current set of electronic transactions. Then, in step 310, the processing server 102 can determine if one or more threshold criteria is met. The determination can utilize different data based on the threshold criteria, which can include determining if the number or percentage of transactions remaining in the filtered set of electronic transactions is below a predetermined threshold value, if the fraud rate of fraudulent transactions identified during rule application is above a predetermined threshold value, etc.

If the processing server 102 determines that the threshold criteria has not been met, then the process 300 can return to step 306 where the rules module 220 can apply the next rule in the plurality of rules to the current set (e.g., after filtering) of the electronic transactions. A subsequent subset of electronic transactions can be accordingly identified in the current set of electronic transactions and then, in step 308, filtered from the current set of electronic transactions. The process 300 can continue repeating steps 306, 308, and 310 until, in step 310, the processing server 102 determines that the threshold criteria has been met. Once the threshold criteria have been met, then, in step 312, the generation module 218 of the processing server 102 can generate an order for the plurality of rules, which can be based on one or more criteria as discussed above, such as a number or percentage of electronic transactions identified via application of the respective rule. In some embodiments, more than one rule order can be identified in step 312, such as in cases where both fraud and approval rules are identified, as discussed above. The generated rule order can then be used in the application of the associated rules to new transactions in fraud scoring and fraud determinations.

In step 314, the receiving device 202 of the processing server 102 can receive transaction data for a new electronic transaction and apply the generated rule order to the new electronic transaction in step 316. For example, a blockchain wallet user may send a new proposed cryptographic currency blockchain transaction to the processing server 102 for fraud determination. The processing server 102 applies the generated rule order to the proposed blockchain transaction. In step 318, the processing server 102 determines whether the new electronic transaction, e.g., the proposed cryptographic currency blockchain transaction, is fraudulent or not based on the application of the generated rule order. If the processing server 102 determines the new electronic transaction is not fraudulent or is not likely to be fraudulent, e.g., by some defined threshold, the processing server 102 approves the new electronic transaction in step 320. In approving the new electronic transaction, the processing server 102 may transmit approval and/or the fraud determination to the sender of the new electronic transaction, for example, if the processing server 102 is authorized to approve transactions on behalf of the blockchain network 104, the payment network 108, and/or the issuer system 110. In some embodiments, in approving the new electronic transaction, the processing server 102 may transmit the fraud determination to the sender blockchain network 104, the payment network 108, and/or the issuer system 110. In some embodiments, the processing server 102 may not be authorized to approve transactions on behalf of the blockchain network 104, the payment network 108, and/or the issuer system 110, and the processing server 102 may transmit the fraud determination to one or more of the sender blockchain network 104, the payment network 108, and/or the issuer system 110 for transaction approval or denial.

Returning to step 318, if the processing server determines the new electronic transaction is fraudulent or is likely to be fraudulent e.g., by some defined threshold, the processing server 102 denies the new electronic transaction in step 322. In denying the new electronic transaction, the processing server 102 may transmit a denial and/or the fraud determination to the sender of the new electronic transaction, for example, if the processing server 102 is authorized to deny transactions on behalf of the blockchain network 104, the payment network 108, and/or the issuer system 110. In some embodiments, in denying the new electronic transaction, the processing server 102 may transmit the fraud determination to the sender blockchain network 104, the payment network 108, and/or the issuer system 110. In some embodiments, the processing server 102 may not be authorized to approve transactions on behalf of the blockchain network 104, the payment network 108, and/or the issuer system 110, and the processing server 102 may transmit the fraud determination to one or more of the sender blockchain network 104, the payment network 108, and/or the issuer system 110 for transaction approval or denial.

### Exemplary Method for Generating Fraud and Approval Rules

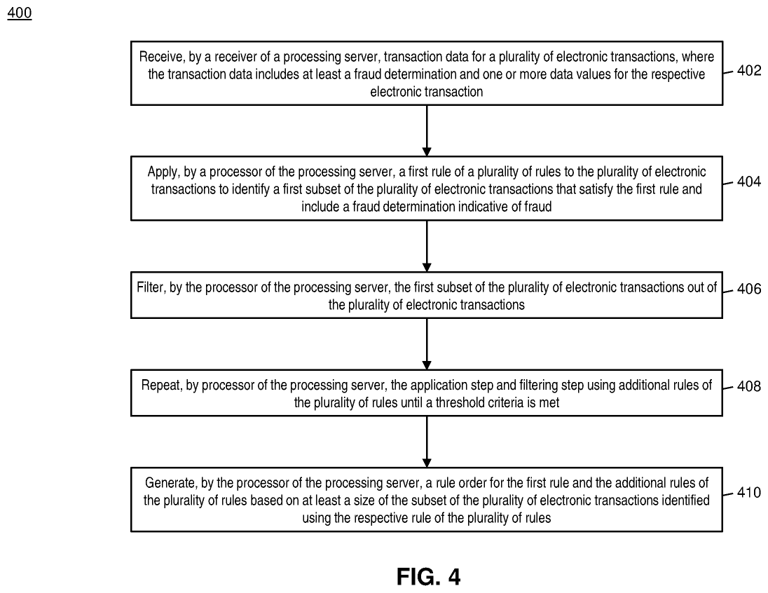

FIG. 4 illustrates a method 400 for the generation of fraud and approval rules for a decision engine for detecting fraud in electronic transactions.

In step 402, transaction data for a plurality of electronic transactions can be received by a receiver (e.g., receiving device 202) of a processing server (e.g., processing server 102) where the transaction data includes at least a fraud determination and one or more data values for the respective electronic transaction. In step 404, a first rule of a plurality of rules can be applied by a processor (e.g., rules module 220) of the processing server to the plurality of electronic transactions to identify a first subset of the plurality of electronic transactions that satisfy the first rule and include a fraud determination indicative of fraud.

In step 406, the processor (e.g., generation module 218) can filter the first subset of the plurality of electronic transactions out of the plurality of electronic transactions. In step 408, the processor of the processing server can repeat the application step (e.g., step 404) and filtering step (e.g., step 406) using additional rules of the plurality of rules until a threshold criteria is met. In step 410, a rule order for the first rule and the additional rules of the plurality of rules can be generated by the processor (e.g., generation module 218) of the processing server based on at least a size of the subset of the plurality of electronic transactions identified using the respective rule of the plurality of rules.

In one embodiment, the method 400 can further include: receiving, by the receiver of the processing server, transaction data for a new electronic transaction; and applying, by the processor of the processing server, the first rule and the additional rules of the plurality of rules to the new transaction data using the generated rule order to generate a new fraud determination for the new electronic transaction. In some embodiments, the threshold criteria can be a number of electronic transactions remaining in the plurality of electronic transactions being below a predetermined threshold value. In one embodiment, the threshold criteria can be a fraud rate for identification of electronic transactions with a positive fraud determination based on a percentage of electronic transactions filtered out from the plurality of electronic transactions.

In some embodiments, applying the first rule of the plurality of rules to the plurality of electronic transactions can further identify a second subset of the plurality of electronic transactions that satisfy the first rule and include a fraud determination indicative of approval. In a further embodiment, filtering the first subset of the plurality of electronic transactions out of the plurality of electronic transactions can include further filtering the second subset of the plurality of electronic transactions out of the plurality of electronic transactions. In an even further embodiment, generating a rule order can include generating a fraud rule order for the first rule and the additional rules of the plurality of rules based on at least a size of the first subset of the plurality of electronic transactions identified using the respective rule of the plurality of rules and generating an approval rule order for the first rule and the additional rules of the plurality of rules based on at least a size of the second subset of the plurality of electronic transactions identified using the respective rule of the plurality of rules. In one embodiment, the electronic transactions can be cryptographic currency transactions processed via a blockchain.

### Computer System Architecture

FIG. 5 illustrates a computer system 500 in which embodiments of the present disclosure, or portions thereof, can be implemented as computer-readable code. For example, the processing server 102, blockchain nodes 106, and issuer system 110 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for generating fraud and approval rules for a decision engine for detecting fraud in electronic transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for generating fraud and approval rules for a decision engine for detecting fraud in electronic transactions, comprising:
receiving, by a receiver of a processing server, transaction data for a plurality of electronic transactions, where the transaction data includes at least a fraud determination and one or more data values for the respective electronic transaction;
applying, by a processor of the processing server, a first rule of a plurality of rules to the plurality of electronic transactions to identify a first subset of the plurality of electronic transactions that satisfy the first rule and include a fraud determination indicative of fraud;
filtering, by the processor of the processing server, the first subset of the plurality of electronic transactions out of the plurality of electronic transactions;
repeating, by processor of the processing server, the application step and filtering step using additional rules of the plurality of rules until a threshold criteria is met; and
generating, by the processor of the processing server, a rule order for the first rule and the additional rules of the plurality of rules based on at least a size of the subset of the plurality of electronic transactions identified using the respective rule of the plurality of rules.

2. The method of claim 1, further comprising:
receiving, by the receiver of the processing server, transaction data for a new electronic transaction; and
applying, by the processor of the processing server, the first rule and the additional rules of the plurality of rules to the new transaction data using the generated rule order to generate a new fraud determination for the new electronic transaction.

3. The method of claim 2, further comprising:
determining, by the processing server, the new electronic transaction is fraudulent based on the application of the first rule and the additional rules of the plurality of rules; and
transmitting, by a transmitter of the processing server, the fraud determination to a third-party for approval or denial and/or one or more parties of the new electronic transaction.

4. The method of claim 2, further comprising:
determining, by the processing server, the new electronic transaction is not fraudulent based on the application of the first rule and the additional rules of the plurality of rules; and
transmitting, by a transmitter of the processing server, the fraud determination to a third-party for approval or denial one or more parties of the new electronic transaction.

5. The method of claim 1, wherein the threshold criteria is a number of electronic transactions remaining in the plurality of electronic transactions being below a predetermined threshold value.

6. The method of claim 1, wherein the threshold criteria is a fraud rate for identification of electronic transactions with a positive fraud determination based on a percentage of electronic transactions filtered out from the plurality of electronic transactions.

7. The method of claim 1, wherein applying the first rule of the plurality of rules to the plurality of electronic transactions further identifies a second subset of the plurality of electronic transactions that satisfy the first rule and include a fraud determination indicative of approval.

8. The method of claim 7, wherein filtering the first subset of the plurality of electronic transactions out of the plurality of electronic transactions includes further filtering the second subset of the plurality of electronic transactions out of the plurality of electronic transactions.

9. The method of claim 8, wherein generating a rule order includes generating a fraud rule order for the first rule and the additional rules of the plurality of rules based on at least a size of the first subset of the plurality of electronic transactions identified using the respective rule of the plurality of rules and generating an approval rule order for the first rule and the additional rules of the plurality of rules based on at least a size of the second subset of the plurality of electronic transactions identified using the respective rule of the plurality of rules.

10. The method of claim 1, wherein the electronic transactions are cryptographic currency transactions processed via a blockchain.

11. A system for generating fraud and approval rules for a decision engine for detecting fraud in electronic transactions, comprising a processing server including:
a receiver receiving transaction data for a plurality of electronic transactions, where the transaction data includes at least a fraud determination and one or more data values for the respective electronic transaction; and
a processor
applying a first rule of a plurality of rules to the plurality of electronic transactions to identify a first subset of the plurality of electronic transactions that satisfy the first rule and include a fraud determination indicative of fraud,
filtering the first subset of the plurality of electronic transactions out of the plurality of electronic transactions,
repeating the application step and filtering step using additional rules of the plurality of rules until a threshold criteria is met, and
generating a rule order for the first rule and the additional rules of the plurality of rules based on at least a size of the subset of the plurality of electronic transactions identified using the respective rule of the plurality of rules.

12. The system of claim 11, wherein
the receiver of the processing server receives transaction data for a new electronic transaction, and
the processor of the processing server applies the first rule and the additional rules of the plurality of rules to the new transaction data using the generated rule order to generate a new fraud determination for the new electronic transaction.

13. The system of claim 12, wherein
the processing server determines the new electronic transaction is fraudulent based on the application of the first rule and the additional rules of the plurality of rules, and
a transmitter of the processing server transmits the fraud determination to a third-party for approval or denial one or more parties of the new electronic transaction.

14. The system of claim 12, further comprising:
the processing server determines the new electronic transaction is not fraudulent based on the application of the first rule and the additional rules of the plurality of rules, and
a transmitter of the processing server transmits the fraud determination to a third-party for approval or denial one or more parties of the new electronic transaction.

15. The system of claim 11, wherein the threshold criteria is a number of electronic transactions remaining in the plurality of electronic transactions being below a predetermined threshold value.

16. The system of claim 11, wherein the threshold criteria is a fraud rate for identification of electronic transactions with a positive fraud determination based on a percentage of electronic transactions filtered out from the plurality of electronic transactions.

17. The system of claim 11, wherein applying the first rule of the plurality of rules to the plurality of electronic transactions further identifies a second subset of the plurality of electronic transactions that satisfy the first rule and include a fraud determination indicative of approval.

18. The system of claim 17, wherein filtering the first subset of the plurality of electronic transactions out of the plurality of electronic transactions includes further filtering the second subset of the plurality of electronic transactions out of the plurality of electronic transactions.

19. The system of claim 18, wherein generating a rule order includes generating a fraud rule order for the first rule and the additional rules of the plurality of rules based on at least a size of the first subset of the plurality of electronic transactions identified using the respective rule of the plurality of rules and generating an approval rule order for the first rule and the additional rules of the plurality of rules based on at least a size of the second subset of the plurality of electronic transactions identified using the respective rule of the plurality of rules.

20. The system of claim 11, wherein the electronic transactions are cryptographic currency transactions processed via a blockchain.
